(19) United States
(12) Patent Application Publication
(10) Pub. No.: US 2018/0074383 A1
(43) Pub. Date: Mar. 15, 2018

(54) ELECTROACTIVE POLYMER MEMBRANE-BASED ACTIVE LENS ASSEMBLIES

(71) Applicant: Massachusetts Institute of Technology, Cambridge, MA (US)

(72) Inventors: Christopher L. Kwok, Cambridge, MA (US); Iman Soltani Bozchalooi, Cambridge, MA (US)

(21) Appl. No.: 15/659,048

(22) Filed: Jul. 25, 2017

Related U.S. Application Data
(60) Provisional application No. 62/394,833, filed on Sep. 15, 2016.

(51) Int. Cl. G02F 1/29

(52) U.S. Cl. CPC G02F 1/29; G02F 2203/18; G02F 2001/294; G02F 2201/12; G02F 2202/022

(57) ABSTRACT

Active lens assemblies based on a deformable lens adhered to an electroactive polymer (EAP) membrane based actuator, active lens systems comprising such active lenses, and methods of actuating a deformable lens are described. The active lenses can provide controllable optical power, withstand constant periods of actuation, have low power consumption, have fewer mechanically moving parts, have fast response times and/or high portability. These benefits are important for use in precision-seeking applications, such as collision avoidance systems in automobiles.

This application claims the benefit of U.S. Provisional Application No. 62/394,833, filed on Sep. 15, 2016. The entire teachings of the above application are incorporated herein by reference.

### BACKGROUND

Active lens assemblies have a variety of uses from photographic capabilities in small mobile devices to applications in engineering. They provide faster response times and higher portability and efficiency when compared to their traditional lens assemblies.

The use of electromagnetic actuators for active lens assemblies has been found to pose issues over long-time use, for example, high power consumption can lead to heating problems, and durability can be insufficient to withstand constant periods of actuation, especially for demands of precision-seeking applications such as collision avoidance systems.

There is a need for new active lens systems including actuators that have controllable optical power, withstand constant periods of actuation, have low power consumption, have fewer mechanically moving parts, have fast response times and/or high portability.

### SUMMARY

Embodiments of lens assemblies based on a deformable lens adhered to an electroactive polymer (EAP) membrane-based actuator are described, which can provide controllable optical power, withstand constant periods of actuation, have low power consumption, have fewer mechanically moving parts, have fast response times and/or high portability. These benefits are important for use in precision-seeking applications such as collision avoidance systems in automobiles.

A first embodiment is an active lens assembly, comprising a deformable lens coupled to a transparent area of a planar polymer membrane on a first side, and conductive material attached to the planar polymer membrane on the first side and on a second side, opposite the first side, of the polymer membrane.

A second embodiment is an active lens system comprising an active lens assembly embodiment as described herein, further comprising (i) a controlled variable resistor, wherein the resistor is connected electrically in parallel to the active lens, (ii) a controlled source of alternating current connected to allow application of a voltage to the conductive material across the first and second side, (iii) and a base having an opening or a transparent area, the active lens assembly having its polymer membrane, at its perimeter, attached to the base and its lens having an aperture over the opening or transparent area of the base.

A third embodiment is a method of actuating a deformable lens, the method comprising (i) providing an active lens system embodiment as described herein, the system having an active lens assembly as described herein and a controlled variable resistor, wherein the resistor is connected electrically in parallel to the active lens, and (ii) controlling in parallel input voltage and resistance of the resistor.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A illustrates the cantilever model of an electroactive polymer (EAP) membrane-based actuator (“EAP actuator”) showing strain in its longitudinal direction.

FIG. 1B provides a schematic showing fixed outer radius and direction of strain of an EAP.

FIG. 2 shows a schematic of an annular region showing inner and outer diameter with a circumferential element with thickness dx.

FIG. 3 provides a circuit diagram with a capacitor and resistor in parallel with each other supplied with an alternating current.

FIG. 4 provides a schematic illustration of an EAP membrane affixed to an acrylic frame with example dimensions of components therein.

FIG. 5 shows an example embodiment of an EAP actuator system.

FIG. 6 provides a graph of capacitance over applied voltage during actuation of an example embodiment of an EAP actuator using specified parameters.

FIG. 7 provides a graph of required resistance over applied voltage during actuation of an example embodiment of an EAP actuator using specified parameters.

FIG. 8 is a side view of a mechanical diagram of an example embodiment of an EAP actuator assembly.

### DETAILED DESCRIPTION

A description of example embodiments follows.

Active Lenses

Active lenses differ from traditional lenses in that they do not specifically require any fixed lenses and they adjust focus not by mechanically displacing a lens in relation to another, but by manipulating a deformable lens. The deformable lens can alter its shape and change its optical properties such that a different focal length can be achieved. In embodiments, this is achieved through actuation based on electroactive polymers. The actuation results in changes to the lens' radius or radii of curvature. The benefits over traditional lenses include efficiency, portability, and faster actuation speeds.

As used herein, a “lens” is an object that focuses or otherwise modifies the direction of movement of light. More specifically, it is an object which is made of a transparent material (i.e., that allows light rays, typically, visible light, to pass through (with some light typically being reflected and other light being absorbed)) and has curved sides for concentrating or dispersing the light rays.

As used herein, a “deformable lens” refers to a lens that can deform as the result of actuation. More specifically, the deformable lens is adapted such that the actuation-based change in the size of the area of a polymer membrane to which the deformable lens is connected, leads to a deformation of the lens, which changes the lens' optical properties, such as, for example, the focal length of the deformable lens. Typically, the deformable lens deforms elastically throughout the actuation range.

Suitable deformable lens materials include, but are not limited, to transparent elastomers such as silicone elastomers (e.g., Sylgard 184).

Electroactive Polymer Membrane-Based Actuators (“EAP Actuators”)

An EAP actuator essentially acts as a capacitor when supplied with a voltage. The EAP actuator can be designed similarly to a parallel plate capacitor that includes a soft dielectric polymer sandwiched between a conductive material that is applied on both sides of its surfaces. During actuation, charges on opposite sides align, thereby establishing an electric field throughout the membrane. Because the polymer is soft, it will compress as the electric field causes both sides of the conductive material to attract toward each other. The magnitude of the electric field, represented by φ:

$$ϕ = \frac{V}{d} \qquad ( Eq . 1 )$$

is directly related to V, the voltage applied, and inversely related to d, the thickness of the dielectric membrane. The established electric field causes a compressive Maxwell stress in the same direction on the membrane, represented by the stress equation

σ_{M}=∈φ^{z} (Eq. 2)

where ∈ is the permittivity of the dielectric material and φ, the electric field. This stress causes the membrane's conductive surface area to increase, while decreasing the same portion in thickness. The membrane in its actuated state is, essentially, both stretched and flattened. This flattening of the EAP actuator causes some of its electrical properties to change. The equation for a parallel plate capacitor is

$$C = \frac{k {ϵ}_{0} A}{d} \qquad ( Eq . 3 )$$

where k is the relative permittivity of the membrane, ∈₀ the permittivity of free space, A the surface area of which the conductive material is applied, and d the thickness. However, Equation 3 is no longer valid since it does not remain constant throughout actuation. Both the surface area and the thickness change as the EAP is actuated. To account for this geometric change, the capacitance of the EAP actuator can be derived as a function of applied voltage, C(V). In order to do so, the changing parameters of the capacitance equation, thickness and area, can also be derived as functions of applied voltage.

The thickness as a function of voltage is derived from the strain equation in the thickness direction

$${ɛ}_{d} = \frac{d ( V ) - {d}_{0}}{{d}_{0}} = \frac{{σ}_{d}}{E} \qquad ( Eq . 4 )$$

where d₀ is the initial thickness of the membrane, σ_{d} is the stress in the thickness direction, and E is the Young's modulus of the membrane. By substituting σ_{d} for Equations 1 and 2 and by rearranging, we obtain an equation for thickness as a function of applied voltage.

$$d ( V ) = {d}_{0} ( 1 - \frac{ϵ {V}^{2}}{{Ed}_{0}^{2}} ) . \qquad ( Eq . 5 )$$

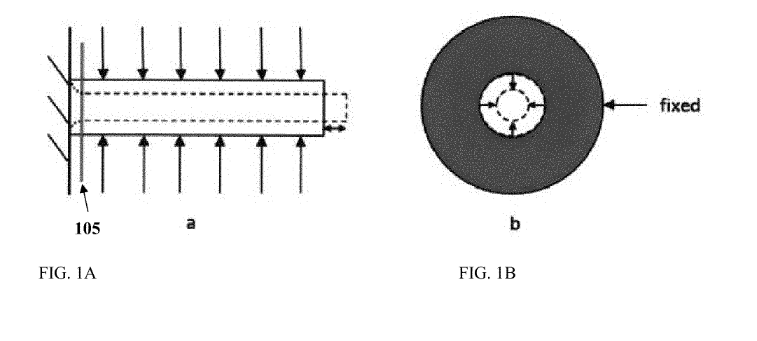

It can be assumed that the electric field remains constant throughout the entire membrane, if conductive material is uniformly applied and the deviations in thickness during actuation are small in comparison to the deviation in surface area. In this case, the EAP actuator in its transverse plane can be modeled as a cantilever fixed at one end with a uniformly distributed load on both sides. The boundary condition is ignored, and thickness is assumed to be uniform along the membrane. A schematic of this model is shown in FIGS. 1A and 1B. Line 105 indicates where the boundary condition is ignored.

In the case of an EAP actuator with conductive material applied within an annular region of the membrane with inner radius, rᵢ, and outer radius, r₀, where the outer radius remains constant, bounded by a rigid frame. The inner radius, however, changes according to applied voltage. Radius is related to the thickness using the Poisson's ratio

$$\begin{matrix}γ = - \frac{{ɛ}_{d}}{{ɛ}_{r}} \\ where & ( Eq . 6 ) \\ {ɛ}_{r} = \frac{Δ r}{{r}_{0} - {r}_{i}} \\ and & ( Eq . 7 ) \\ Δ r = {r}_{i} - {r}_{i}^{′} ( V ) = {\int }_{{r}_{i}}^{{r}_{0}} {ɛ}_{r} ( V ) dr = ( {r}_{0} - {r}_{i} ) \frac{d ( V ) - {d}_{0}}{{d}_{0} γ} & ( Eq . 8 )\end{matrix}$$

By substituting for thickness and rearranging, obtained is

$${r}_{i}^{′} ( V ) = {r}_{i} - \frac{( {r}_{0} - {r}_{i} ) ϵ {V}^{2}}{γ {Ed}_{0}^{2}} . \qquad ( Eq . 9 )$$

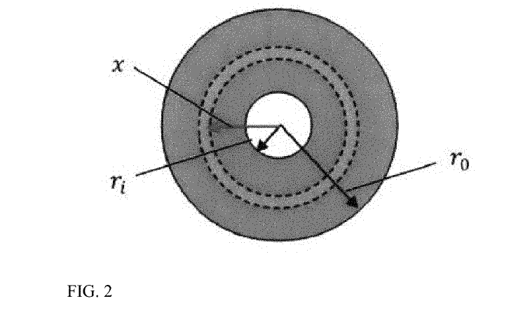

FIG. 2 shows a circumferential element taken at radius, x, with an area of A=2πx dx along with the dimensions, rᵢ and r₀. By substituting the equations for area and thickness into Equation 3, a definite integral for capacitance as a function of voltage

$$C ( V ) = {\int }_{{r}_{i} ( V )}^{{r}_{0}} k {ϵ}_{0} \frac{2 π x dx}{d ( V )} \qquad ( Eq . 10 )$$

is given, where the area is integrated by rᵢ(V), the surface area component dependent on voltage, and the outer radius. The resulting equation

$$C ( V ) = \frac{k {ϵ}_{0} π}{d ( V )} [ {r}_{0}^{2} - {{r}_{i}^{′} ( V )}^{2} ] \qquad ( Eq . 11 )$$

is then obtained. Capacitance can now be calculated for the EAP actuator, given an applied voltage.

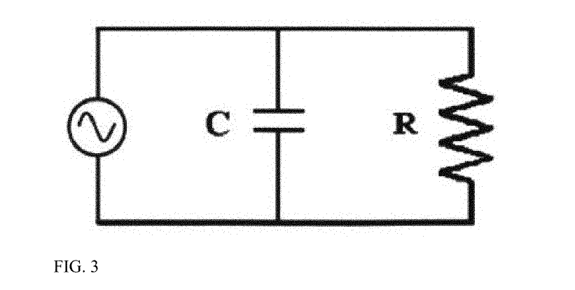

In order to control the actuation of the EAP actuator, input voltage can be controlled by some function (e.g., a sine wave). Also, in order for the membrane of the EAP actuator to contract and relax in phase with the control function), a parallel resistance can be added. This resistance provides a pathway for discharge during actuation such that the EAP actuator does not remain in its actuated state. Without this resistance, the EAP actuator will discharge over a longer time, nullifying the purpose of a control function. An example schematic for a resistance-capacitance (RC) circuit is shown in FIG. 3.

The Time Constant for an RC Circuit

τ=RC (Eq. 12)

is the product of the circuit resistance and its capacitance. This time constant, τ, is used to determine the behavior of the EAP actuator and specify an actuation speed. Using Equation 12 with the equations for capacitance, a specific range for resistance can be defined that allows for steady discharge for a specific actuation frequency.

Focal Length and Lens Shape

The Lensmaker's Equation

$$\frac{1}{f} = ( i - 1 ) [ \frac{1}{{R}_{1}} - \frac{1}{{R}_{2}} + \frac{( i - 1 ) d}{{iR}_{1} {R}_{2 }} ] \qquad ( Eq . 13 )$$

where f is the focal length of the lens, i the refractive index, R₁ and R₂ are the radius of curvature for both sides of the lens, and d the thickness of the lens, can be used to calculate the focal length range of an active lens. As the shape of an active lens changes, so does its radii of curvature, resulting in a different focal length. A focal length range can be determined by inputting the maximum and minimum radii of curvature into the lensmaker's equation. For a plano-convex/plano-concave lens (one with a side that is flat), the radius becomes infinity, which cancels out the corresponding term in the equation, and upon actuation, the planar side does not change.

For evaluating lens geometries with regard to focal length, the volume of a lens can be approximated by that of a spherical cap. When a single lens is actuated, the volume of said lens remains constant. Therefore, by using the spherical cap equation, one can determine whether a lens configuration is feasible for the desired focal length limits. The equation for volume of a spherical cap is

$$V = \frac{π h}{6} ( 3 {a}^{2} + {h}^{2} ) . \qquad ( Eq . 14 )$$

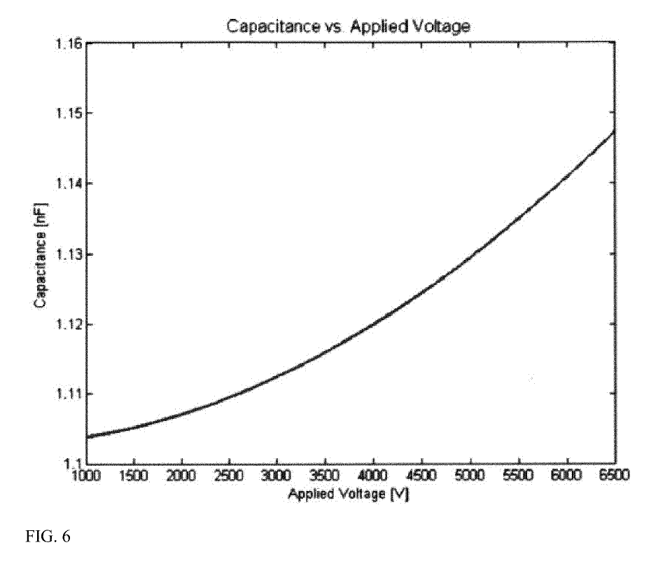

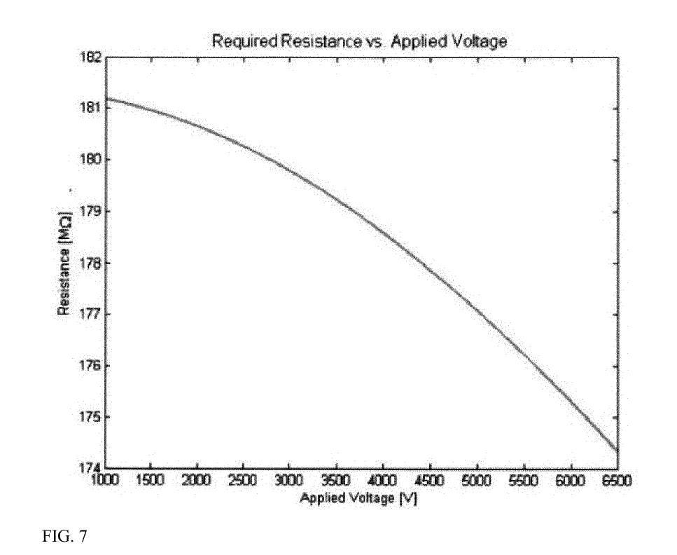

By using Equation 11, the capacitance of the EAP actuator can be predicted over an applied voltage range, which is shown in FIG. 6. This shows a nonlinear relationship between the two parameters. As capacitance changes during actuation, resistance must also change in order to accommodate for the time constant as explained with Equation 12, the RC circuit relationship. As the capacitance increases, the resistance must decrease in order for the actuation of the EAP actuator to remain in phase with the control signal. Should the EAP actuator begin to drift out of phase from an unaccommodating resistor, smooth and continuous actuation will not be realized. FIG. 7 was generated by substituting Equation 11 into Equation 12 and shows how resistance must change over an applied voltage range. The outer diameter of the EAP actuator was set to 4.0 inches, with inner radius of 0.91 inches as specified above, and the time constant used was 0.44 m⁻¹. Thus, a controllable variable resistor can be implemented to allow for actuation of the EAP actuator to remain in phase with the control signal.

A first embodiment is an active lens assembly, comprising: a deformable lens coupled to a transparent area of a planar polymer membrane on a first side, and conductive material attached to the planar polymer membrane on the first side and on a second side, opposite the first side, of the polymer membrane.

In one embodiment of the active lens assembly of the first embodiment, at least part of the polymer membrane is sandwiched by the conductive material. In a further aspect of this embodiment or foregoing aspect of this embodiment, the conductive material is attached in a thin layer. In yet a further aspect of this embodiment or foregoing aspect of this embodiment, the thin layer of conductive material on the first side and the second side have the same thickness. In yet a further aspect of this embodiment or foregoing aspect of this embodiment, the thin layer of conductive material on the first side and the second side have thicknesses that do not differ by more than 100%, 80%, 60%, 40%, 20%, 10%, 5%, 2%, 1%, 0.5%, or 0.1% (relative to the thickness of the conductive material which has a smaller thickness). In yet a further aspect of this embodiment or foregoing aspect of this embodiment, the conductive material on the first side is positioned around the deformable lens. In yet a further aspect of this embodiment or foregoing aspect of this embodiment, the conductive material forms, on the first side, a first annular ring surrounding the deformable lens. In yet a further aspect of this embodiment or foregoing aspect of this embodiment, the conductive material forms, on the first side, a first annular ring surrounding the deformable lens, and the conductive material forms, on the second side, a second annular ring, the first and second annular rings being positioned opposite to each other. In yet a further aspect of this embodiment or foregoing aspect of this embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In another embodiment of the active lens assembly of the first embodiment, the conductive material is attached in a thin layer. In yet a further aspect of this embodiment or foregoing aspect of this embodiment, the thin layer of conductive material on the first side and the second side have the same thickness. In yet a further aspect of this embodiment or foregoing aspect of this embodiment, the thin layer of conductive material on the first side and the second side have thicknesses that do not differ by more than 100%, 80%, 60%, 40%, 20%, 10%, 5%, 2%, 1%, 0.5%, or 0.1% (relative to the thickness of the conductive material which has a smaller thickness). In yet a further aspect of this embodiment or foregoing aspect of this embodiment, the conductive material on the first side is positioned around the deformable lens. In yet a further aspect of this embodiment or foregoing aspect of this embodiment, the conductive material forms, on the first side, a first annular ring surrounding the deformable lens. In yet a further aspect of this embodiment or foregoing aspect of this embodiment, the conductive material forms, on the first side, a first annular ring surrounding the deformable lens, and the conductive material forms, on the second side, a second annular ring, the first and second annular rings being positioned opposite to each other. In yet a further aspect of this embodiment or foregoing aspect of this embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the thin layer of conductive material on the first side and the second side have the same thickness. In yet a further aspect of this embodiment or foregoing aspect of this embodiment, the thin layer of conductive material on the first side and the second side have thicknesses that do not differ by more than 100%, 80%, 60%, 40%, 20%, 10%, 5%, 2%, 1%, 0.5%, or 0.1% (relative to the thickness of the conductive material which has a smaller thickness). In yet a further aspect of this embodiment or foregoing aspect of this embodiment, the conductive material on the first side is positioned around the deformable lens. In yet a further aspect of this embodiment or foregoing aspect of this embodiment, the conductive material forms, on the first side, a first annular ring surrounding the deformable lens. In yet a further aspect of this embodiment or foregoing aspect of this embodiment, the conductive material forms, on the first side, a first annular ring surrounding the deformable lens, and the conductive material forms, on the second side, a second annular ring, the first and second annular rings being positioned opposite to each other. In yet a further aspect of this embodiment or foregoing aspect of this embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the thin layer of conductive material on the first side and the second side have thicknesses that do not differ by more than 100%, 80%, 60%, 40%, 20%, 10%, 5%, 2%, 1%, 0.5%, or 0.1% (relative to the thickness of the conductive material which has a smaller thickness). In yet a further aspect of this embodiment or foregoing aspect of this embodiment, the conductive material on the first side is positioned around the deformable lens. In yet a further aspect of this embodiment or foregoing aspect of this embodiment, the conductive material forms, on the first side, a first annular ring surrounding the deformable lens. In yet a further aspect of this embodiment or foregoing aspect of this embodiment, the conductive material forms, on the first side, a first annular ring surrounding the deformable lens, and the conductive material forms, on the second side, a second annular ring, the first and second annular rings being positioned opposite to each other. In yet a further aspect of this embodiment or foregoing aspect of this embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the conductive material on the first side is positioned around the deformable lens. In yet a further aspect of this embodiment or foregoing aspect of this embodiment, the conductive material forms, on the first side, a first annular ring surrounding the deformable lens. In yet a further aspect of this embodiment or foregoing aspect of this embodiment, the conductive material forms, on the first side, a first annular ring surrounding the deformable lens, and the conductive material forms, on the second side, a second annular ring, the first and second annular rings being positioned opposite to each other. In yet a further aspect of this embodiment or foregoing aspect of this embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the conductive material on the first side is positioned around the deformable lens. In yet a further aspect of this embodiment or foregoing aspect of this embodiment, the conductive material forms, on the first side, a first annular ring surrounding the deformable lens. In yet a further aspect of this embodiment or foregoing aspect of this embodiment, the conductive material forms, on the first side, a first annular ring surrounding the deformable lens, and the conductive material forms, on the second side, a second annular ring, the first and second annular rings being positioned opposite to each other. In yet a further aspect of this embodiment or foregoing aspect of this embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the conductive material forms, on the first side, a first annular ring surrounding the deformable lens. In yet a further aspect of this embodiment or foregoing aspect of this embodiment, the conductive material forms, on the first side, a first annular ring surrounding the deformable lens, and the conductive material forms, on the second side, a second annular ring, the first and second annular rings being positioned opposite to each other. In yet a further aspect of this embodiment or foregoing aspect of this embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the conductive material forms, on the first side, a first annular ring surrounding the deformable lens, and the conductive material forms, on the second side, a second annular ring, the first and second annular rings being positioned opposite to each other. In yet a further aspect of this embodiment or foregoing aspect of this embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the conductive material is deposited on the polymer membrane. In yet a further aspect of this embodiment or foregoing aspect of this embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, no conductive material is on the second side in the area opposite the lens. In yet a further aspect of this embodiment or foregoing aspect of this embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the polymer membrane is circular. In yet a further aspect of this embodiment or foregoing aspect of this embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the deformable lens, when unactuated, is characterized by an aperture of between 1 mm and 50 mm and a focal length between 25 and 400 mm, or an aperture of between 5 mm and 25 mm and a focal length between 50 and 200 mm. In yet a further aspect of this embodiment or foregoing aspect of this embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the deformable lens is spherical and has a positive radius of curvature. In yet a further aspect of this embodiment or foregoing aspect of this embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the deformable lens is comprised of a material having a refractive index that differs in value by less than 25%, 20%, 15%, 10%, 8%, 6%, 4%, 3%, 2%, 1%, 0.5%, 0.25%, 0.1%, 0.01% or 0.001% from the refractive index of the polymer membrane in the transparent area. In yet a further aspect of this embodiment or foregoing aspect of this embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the conductive material is graphite or carbon nanotubes. In yet a further aspect of this embodiment or foregoing aspect of this embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the polymer membrane is an acrylic polymer. In yet a further aspect of this embodiment or foregoing aspect of this embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the deformable lens is comprised of a clear silicone material. In yet a further aspect of this embodiment or foregoing aspect of this embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

In yet another embodiment of the active lens assembly of the first embodiment, the planar polymer membrane has a thickness between 0.1 mm and 4 mm, 0.15 mm and 3 mm, 0.2 mm and 2 mm, 0.2 mm and 1 mm, or 0.2 mm and 0.5 mm.

A further embodiment of the present invention is an active lens system comprising an active lens assembly of (1) the first embodiment, (2) any of the embodiments of the first embodiment described above, or (3) any of the aspects of these embodiments described above. The active lens system further comprises (i) a controlled variable resistor, wherein the resistor is connected electrically in parallel to the active lens, (ii) a controlled source of alternating current connected to allow application of a voltage to the conductive material across the first and second side, (iii) and a base having an opening or a transparent area, the active lens assembly having its polymer membrane, at its perimeter, attached to the base and its lens having an aperture over the opening or transparent area of the base.

A further embodiment of the present invention is a method of actuating a deformable lens, the method comprising (i) providing an active lens system having an active lens assembly of (1) the first embodiment, (2) any of the embodiments of the first embodiment described above, or (3) any of the aspects of these embodiments described above, and a controlled variable resistor, the resistor is connected electrically in parallel to the active lens, and (ii) controlling in parallel input voltage and resistance of the resistor.

### EXAMPLES

### Example: EAP Actuator

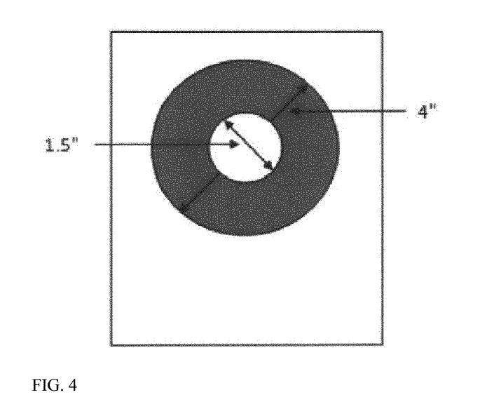

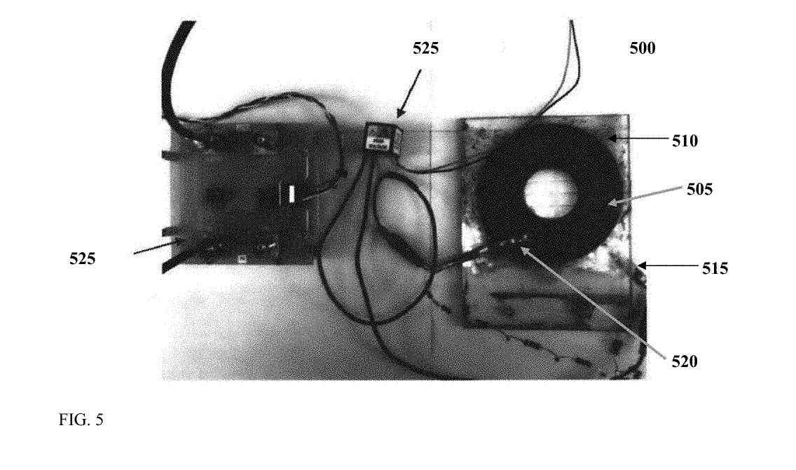

The electroactive polymer was made using 3M® VHB 4905 tape (0.5 mm thick) as the membrane material and graphite powder as the conductive material. The tape is a derivative of an acrylic polymer with a Poisson's ratio of about 0.35. It was stretched approximately 3 times in both directions to fit and adhere to a quarter-inch thick acrylic frame with a circular diameter of 4 inches. Graphite powder was deposited to both sides of the membrane creating an annular region, leaving 1.5 inches of clear space at the center of the membrane. FIG. 4 provides a schematic illustration of the EAP actuator and acrylic frame, and FIG. 5 shows an EAP actuator system 500 including the double-sided graphite coated annular EAP actuator (illustrated in FIG. 4) 505 with outer radius affixed to the acrylic frame 510, and electrical connections 515 and 520 from each graphite coated side of the EAP to a high voltage converter 525 (EMCO model Q80), which received an input voltage from a power buffer (gain of 1) 530.

The EAP actuator system 500 of FIG. 4 was tested with a TEKTRONIX® AFG3022B function generator and Global Specialties 1301A DC power supply used with a laboratory made power buffer (gain of 1). The high voltage unit was directly connected to the EAP actuator. The high voltage converter has an input voltage range from 0 to 5 volts—with a threshold voltage of 0.7 volts—and an output range from 1500V to 8000V. An input range of 0.8V to 4.0V was used for actuating the EAP actuator, resulting in an output voltage of around 1500V to 6500V.

To enable the EAP actuator to discharge, a parallel resistance was added with the unit and EAP actuator. The function generator was set to a 1 Hz sine wave alternating between 0.8V to 4.0V and the corresponding resistance needed was calculated using Equation 12. A measured difference of 0.2 inches in diameter was observed at maximum actuation:

| | EAP tested |
|---|---|
| Input Voltage Range [V] | 0.8 to 4.0 |
| Diameter Difference [%] | ~13.3 |
| Diameter Difference [in] | 1.5 to 1.3 |
| Capacitance Range [nF] | 1.0 to 1.1 |

### Example: EAP Actuator Active Lens Assembly

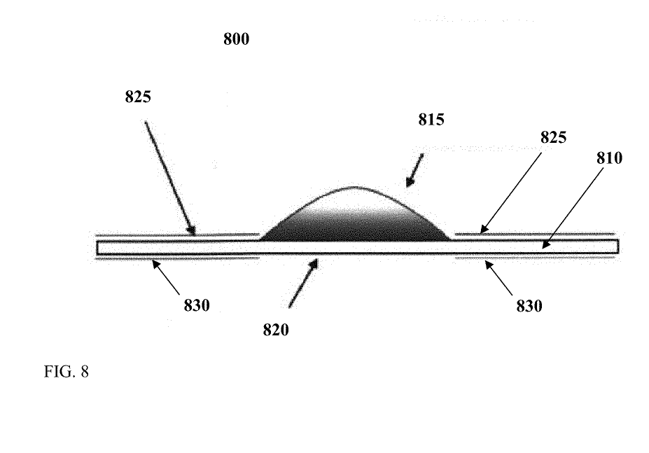

An EAP actuator active lens assembly 800, as shown, in cross-sectional view, in FIG. 8, is formed with an outer diameter of the EAP membrane 810 of 4.0 inches, and having an inner radius of 0.91 inches. Based on Equation 12, given a diameter decrease of 13.3% as observed in the preceding example, a focal length range from ˜113 to 200 mm is obtained. A solid state lens 815, for example, made of a clear silicone material adheres to an EAP membrane 810 in the circular center region 820 of the EAP membrane, which is free of conductive material, here, graphite, which forms an annular region, on both sides (825 deposited on top, and 830 deposited on bottom), around the solid state lens 815.

The electroactive polymer can be made using 3M® VHB 4905 tape (0.5 mm thick) as the membrane material and graphite powder as the conductive material. The lens can be first cast using a clear silicone material and then adhered to the transparent region of the EAP actuator. When the EAP actuator is actuated, the deformation of the membrane compresses the lens radially and ultimately changes its radius of curvature.

The EAP actuator active lens assembly is integrated as part of an active lens system, which includes connection of the conductive material of the EAP actuator to a high voltage converter, a controllable variable resistor, a buffer, and a power source.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. An active lens assembly, comprising: a deformable lens coupled to a transparent area of a planar polymer membrane on a first side, and conductive material attached to the planar polymer membrane on the first side and on a second side, opposite the first side, of the polymer membrane.

2. The active lens assembly of claim 1, wherein at least part of the polymer membrane is sandwiched by the conductive material.

3. The active lens assembly of claim 1, wherein the conductive material is attached in a thin layer.

4. The active lens assembly of claim 3, wherein the thin layer of conductive material on the first side and the second side have the same thickness.

5. The active lens assembly of claim 4, wherein the conductive material on the first side is positioned around the deformable lens.

6. The active lens assembly of claim 5, wherein the conductive material forms, on the first side, a first annular ring surrounding the deformable lens.

7. The active lens assembly of claim 5, wherein the conductive material forms, on the first side, a first annular ring surrounding the deformable lens, and the conductive material forms, on the second side, a second annular ring, the first and second annular rings being positioned opposite to each other.

8. The active lens assembly of claim 7, wherein the conductive material is deposited on the polymer membrane.

9. The active lens assembly of claim 8, wherein no conductive material is on the second side in the area opposite the lens.

10. The active lens assembly of claim 7, wherein the polymer membrane is circular.

11. The active lens assembly of claim 10, wherein the deformable lens, when unactuated, is characterized by an aperture of between 5 mm and 25 mm and a focal length between 50 and 200 mm.

12. The active lens assembly of claim 11, wherein the deformable lens is spherical and has a positive radius of curvature.

13. The active lens assembly of claim 12, wherein the deformable lens is comprised of a material having a refractive index that differs in value by less than 1% from the refractive index of the polymer membrane in the transparent area.

14. The active lens assembly of claim 13, wherein the conductive material is graphite or carbon nanotubes.

15. The active lens assembly of claim 14, wherein the polymer membrane is an acrylic polymer.

16. The active lens assembly of claim 15, wherein the deformable lens is comprised of a clear silicone material.

17. The active lens assembly of claim 1, wherein the planar polymer membrane has a thickness between 0.2 mm and 2 mm.

18. An active lens system comprising an active lens assembly of claim 1, further comprising (i) a controlled variable resistor, wherein the resistor is connected electrically in parallel to the active lens, (ii) a controlled source of alternating current connected to allow application of a voltage to the conductive material across the first and second side, (iii) and a base having an opening or a transparent area, the active lens assembly having its polymer membrane, at its perimeter, attached to the base and its lens having an aperture over the opening or transparent area of the base.

19. A method of actuating a deformable lens, the method comprising (i) providing an active lens system having an active lens assembly of claim 1 and a controlled variable resistor, wherein the resistor is connected electrically in parallel to the active lens, and (ii) controlling in parallel input voltage and resistance of the resistor.
